(19) United States
(12) Patent Application Publication
(10) Pub. No.: US 2007/0004839 A1
(43) Pub. Date: Jan. 4, 2007

(54) HIGHLY DISPERSIBLE INORGANIC COMPOUND NANOPARTICLES AND METHOD OF PRODUCTION THEREOF

(75) Inventors: Akira YAMAMOTO, Tokyo (JP); Yusuke IIMORI, Tokyo (JP); Mae KOYAMA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/428,418

(22) Filed: Jul. 3, 2006

(30) Foreign Application Priority Data
Jul. 4, 2005 (JP) 2005-194996

(51) Int. Cl. C08K 3/32

(52) U.S. Cl. 524/417

(57) ABSTRACT

Highly dispersible inorganic compound nanoparticles include a high molecular nitrogen compound having at least two amino groups selected from primary amino groups, secondary amino groups and tertiary amino groups; and inorganic compound nanoparticles bonded to at least one amino group of the at least two amino groups. The inorganic compound nanoparticles are covered with the high molecular nitrogen compound.

### BACKGROUND OF THE INVENTION

1. Field of the Invention

The present invention relates to highly dispersible inorganic compound nanoparticles having good dispersibility and the method of production thereof.

2. Description of the Prior Art

Recently, nanotechnology research has been widely carried out and atomization (nanoparticle formation) processes of many kinds of substances used as materials are being researched in various industrial fields. Because such nanoparticle-forming materials show an improvement of flowability, an increase in surface area and an enhancement of reactivity on the surface, by applying such a change of physical properties, an improvement in density at the time of compression molding, an increase in adsorption capacity, an improvement of a function as a chemical reaction catalyst, and the productivity of a composite with other materials can be achieved easily. The functionalization of nanoparticles to other materials is commonly achieved by mixing or forming a composite with other materials in the field of coatings, surface modification materials, cosmetics, high refraction index glasses, ceramics, strong magnetic materials and semiconductors materials, etc.

Accordingly, nanoparticle formation of substances has become extremely important technology, and there are prospects for application thereof to the field of chemistry, biochemistry, molecular biology and medical science. Recently, experiments have been made with very small particles being combined with a labeled compound to identify, detect, quantify and visualize a specific molecular structure. Calcium phosphate compound and silica which have very excellent stability at the time of preservation and are harmless to a living body are used as particles. If such particles can be used in nanoparticle form, it is possible to combine them with much more labeled compounds so that a large improvement in sensitivity is achievable.

However, because inorganic compound nanoparticles have a strong aggregation property in a solution, since when the surfaces of the particles are covered with the labeled compounds, the aggregation property thereof is strengthened, the particles becomes bulky causing deterioration of sensitivity.

### SUMMARY OF THE INVENTION

The present invention provides highly dispersible inorganic nanoparticles with good dispersibility by suppressing the aggregation of inorganic compound nanoparticles to modify the surfaces, and provides an efficient method of production thereof.

The present invention has been devised based on the finding that polyamine compound shows strong adsorptivity for inorganic compound particles and can improve the dispersibility of inorganic compound particles.

According to an aspect of the present invention, highly dispersible inorganic compound nanoparticles are provided, including a high molecular nitrogen compound having at least two amino groups selected from primary amino groups, secondary amino groups and tertiary amino groups; and inorganic compound nanoparticles bonded to at least one amino group of the at least two amino groups. The inorganic compound nanoparticles are covered with the high molecular nitrogen compound.

It is desirable for the number average molecular weight of the high molecular nitrogen compound to be in a range from 800 to 100,000.

It is desirable for the high molecular nitrogen compound to include, in the molecular thereof, primary amino groups, secondary amino groups, and tertiary amino groups in a repeating unit.

It is desirable for the high molecular nitrogen compound to be one of a straight-chain, a branched-chain and a cyclic polyamine compound or a mixture thereof.

It is desirable for the polyamine compound to be polyethylene imine.

It is desirable for the inorganic compound to be one of calcium phosphate compound and metal oxide.

It is desirable for the calcium phosphate compound to be hydroxyapatite.

It is desirable for the metal oxide to be one of alumina, silica, magnesium oxide, and iron oxide.

In an embodiment, a method of production for highly dispersible inorganic compound nanoparticles is provided, including mixing inorganic nanoparticles with a high molecular nitrogen compound having at least two amino groups selected from primary amino groups, secondary amino groups, and tertiary amino groups; ultrasonicating the mixture of the inorganic nanoparticles with the high molecular nitrogen compound after the mixing; centrifuging the mixture after the ultrasonication; collecting the supernatant of the mixture after the centrifuging; and drying the supernatant.

It is desirable for the number average molecular weight of the high molecular nitrogen compound to be in a range from 800 to 100,000.

It is desirable for the high molecular nitrogen compound to include, in the molecular thereof, primary amino groups, secondary amino groups, and tertiary amino groups in a repeating unit.

It is desirable for the high molecular nitrogen compound to include one of a straight-chain, a branched-chain and a cyclic polyamine compound or a mixture thereof.

It is desirable for the polyamine compound to be polyethylene imine.

It is desirable for the inorganic compound to be one of calcium phosphate compound and metal oxide.

It is desirable for the calcium phosphate compound to be hydroxyapatite.

It is desirable for the metal oxide to be one of alumina, silica, magnesium oxide and iron oxide. It is desirable for a solvent for the high molecular nitrogen compound to be one of water and an organic solvent.

The present disclosure relates to subject matter contained in Japanese Patent Application No. 2005-194996 (filed on Jul. 4, 2005) which is expressly incorporated herein in its entirety.

### BRIEF DESCRIPTION OF THE DRAWINGS

The present invention will be discussed below in detail with reference to the accompanying drawings, in which:

FIG. 1 shows a molecular formula of ethyleneimine monomer;

FIG. 2 shows a molecular structure of polyethylene imine;

FIG. 3 shows a molecular structure of polyethylene imine consisting only of primary and secondary amino groups;

FIG. 4 shows a molecular structure of polyethylene imine consisting only of primary and tertiary amino groups;

FIG. 5 is a transmission electron microphotograph of hydroxyapatite nanoparticles with PEI coatings prepared in Example 1;

FIG. 6 is a graph of a particle size distribution of hydroxyapatite nanoparticles with PEI coatings prepared in Example 1;

FIG. 7 is a transmission electron microphotograph of magnesium oxide nanoparticles with PEI coatings prepared in Example 2;

FIG. 8 is a graph of a particle size distribution of magnesium oxide nanoparticles with PEI coatings prepared in Example 2;

FIG. 9 is a transmission electron microphotograph of hydroxyapatite nanoparticles with PEI coatings of the number average molecular of 70000;

FIG. 10 is a graph of a particle size distribution of hydroxyapatite nanoparticles with PEI coatings of the number average molecular weight of 70000;

FIG. 11 is a transmission electron microphotograph of hydroxyapatite nanoparticles covered with PEI of the number average molecular weight of 10000;

FIG. 12 is a graph of a particle size distribution of hydroxyapatite nanoparticles covered with PEI of the number average molecular weight of 10000;

FIG. 13 is a transmission electron microphotograph of hydroxyapatite nanoparticles covered with PEI of the number average molecular weight of 1800;

FIG. 14 is a graph of a particle size distribution of hydroxyapatite nanoparticles covered with PEI of the number average molecular weight of 1800;

FIG. 15 is a transmission electron microphotograph of hydroxyapatite nanoparticles (not covered);

FIG. 16 is a graph of a particle size distribution of hydroxyapatite nanoparticles (not covered);

FIG. 17 is a transmission electron microphotograph of magnesium oxide nanoparticles (not covered); and

FIG. 18 is a graph of a particle size distribution of magnesium oxide nanoparticles (not covered).

### DESCRIPTION OF THE PREFERRED EMBODIMENTS

Highly dispersible inorganic compound nanoparticles of the present invention are inorganic compound nanoparticles covered with high molecular nitrogen compounds.

The high molecular nitrogen compound may have at least two amino groups selected from primary amino groups, secondary amino groups and tertiary amino groups in the molecular; for example polyamine compound can be used. The polyamine compound can be a straight-chain, branched-chain or cyclic compound, and if a plurality of the primary amino groups, secondary amino groups and tertiary amino groups exist in a repeating unit structure in a molecule, the bonding sites for the inorganic compound nanoparticles desirably increase.

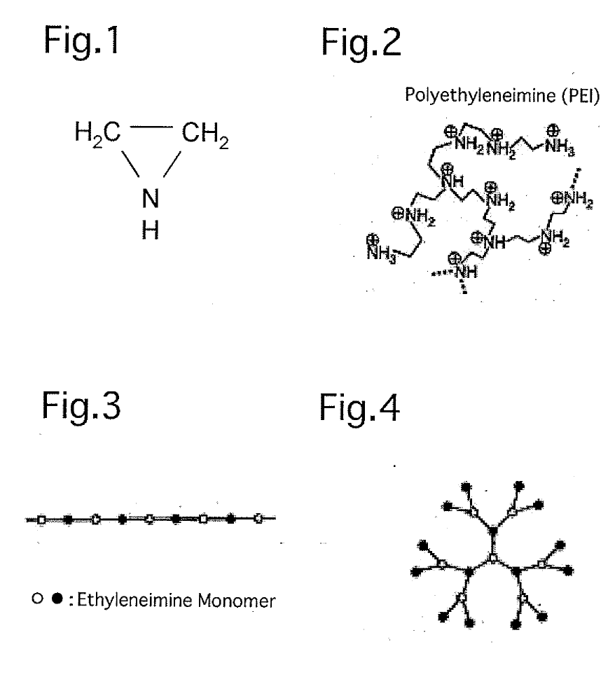

Furthermore, polyethylene imine compound or polylysine, etc., can be used and polyethylene imine (FIG. 2) is particularly suitable. Polyethylene imine is a polymer of ethyleneimine (FIG. 1) and the chemical structure is different depending on the amino group concerned with the reaction. FIG. 3 is a schematic diagram showing a molecular structure of polyethylene imine consisting of only primary amino groups and secondary amino groups, and FIG. 4 is a schematic diagram showing a molecular structure of polyethylene imine consisting of only primary amino groups and tertiary amino groups.

It is desirable for the number average molecular weight of polyamine compound (high molecular nitrogen compound) is 800 to 100,000. A number average molecular weight of less than 800 may cause difficulty for the polyamine compound to cover the inorganic compound nanoparticles completely, and therefore, being difficult to attain good dispersibility because the particles are bonded to each other. Furthermore, the number average molecular weight of above 100,000 may prevent good dispersibility from being attained because the polyamine compounds are bonded each other to form large agglomerates.

Highly dispersible inorganic nanoparticles according to the present invention are covered with high molecular nitrogen compounds by bonding the inorganic compound nanoparticles at a solid acidity (electron pair receptor) to at least one of amino groups in the high molecular nitrogen compound. Calcium phosphate compound or metal oxide can be used as an inorganic compound.

A calcium phosphate compound having a Ca/P ratio of 1.0 to 2.0 may be used as the calcium phosphate compound, and typical examples thereof include a variety of apatites such as hydroxyapatite and fluoroapatite, calcium primary phosphate, calcium secondary phosphate, tricalcium phosphate, and tetracalcium phosphate. These calcium phosphate compounds may be used alone or as a mixture thereof.

Furthermore aluminium oxide, silicon dioxide, magnesium oxide, titanium oxide, iron oxide(hematite) are examples of metal oxides which can be used.

It is desirable for nanoparticles of an inorganic compound used in the present invention to have an average particle size of 2 nm to 1000 nm (1 μm). It is difficult to produce enough particles with an average particle size of less than 2 nm for industrial use. On the other hand, when the particle size is more than 1000 nm, the particles do not agglomerate much and disperse comparatively well by themselves.

The inorganic compound nanoparticles to be used as a starting material can be finely divided particles adhered to nanoparticles or a nanoparticle agglomerate, prepared according to a desired method.

For example, the method of production of the calcium phosphate compound nanoparticles developed by the present inventors are described as follows. Namely, the calcium phosphate compound nanoparticles are prepared by thermal treating a calcium phosphate compound, dispersing the obtained calcium phosphate compound particles in an organic solvent, crushing the particles, centrifuging the obtained calcium phosphate compound dispersion liquid, collecting the supernatant and, if necessary, are dried. In this method, the thermal treated calcium phosphate compound particles can be treated in a ball mill before crushing.

It is desirable for the calcium phosphate compound, used for the above-mentioned method as a raw material, to be synthesized by a known process, dried before heat treating, and granulated if necessary. Granulation can be performed by a known process, however, it is desirable for a porous body to be made at a volume ratio of more than 70% with a spray-dry process.

In the above method, calcium phosphate compound is firstly thermally treated using a known method to provide a thermal history. The heating temperature is not restricted, however it is desirable for the heating process to be performed at a temperature of about 400° C. to 1050° C. When the temperature of the heating process is lower than 400° C., the sufficient strength can not be obtained, and if the temperature is higher than 1050° C., a part or all of the particles sinter, reducing the yield of the nanoparticles.

After thermal treating, the particles are dispersed in an organic solvent by a crush treatment such as, for example, ultrasonication, homogenizing treatment, a shaker or a mortar. It is desirable for a polar organic solvent, for example, alcohol (such as ethanol, isopropanol), ether (such as 2-ethoxyethanol), acetonitrile, tetrahydrofuran and dimethyl sulfoxide, be used as an organic solvent.

Before the crushing process, calcium phosphate compound particles can be treated in a ball mill apparatus. Generally the ball mill apparatus uses balls (media) that crush the sample material with grinding movement, however, if the treatment is performed without using balls so as to obtain a high yield of spherical nanoparticles (an aspect ratio thereof being almost 1). It is desirable that this treatment is carried out under dry conditions (hereinafter referred to as a dry mill treatment) without using an organic solvent (i.e., only calcium phosphate compound is set in the pot).

The calcium phosphate compound dispersion liquid obtained is centrifuged to fractionate a supernatant containing calcium phosphate compound nanoparticles dispersed in an organic solvent layer and a deposit consisting of particles having a larger particle size. Thereafter, the organic solvent in the supernatant is evaporated to obtain calcium phosphate compound nanoparticles.

Highly dispersible inorganic compound nanoparticles according to the present invention can be prepared by mixing the inorganic compound nanoparticles and the high molecular nitrogen compound solution, having at least two amino groups selected from primary amino groups, secondary amino groups and tertiary amino groups, ultrasonicating and then centrifuging, collecting the supernatant, and drying.

Since the dispersibility of high molecular inorganic compound nanoparticles does not show an apparent difference depending on the kind of solvent of the high molecular nitrogen compound solution used in the present invention, it is possible to use any desirable solvent which can dissolve a high molecular nitrogen compound to be used as a solvent used in the production of the high molecular nitrogen compound solution. Water or alcohols (for example, ethanol or isopropanol) can be used as a solvent if the high molecular nitrogen compound is, for example, PEI.

In addition, the concentration of the high molecular nitrogen compound used is dependent on the sort, quantity and the surface area, etc., of the inorganic compound nanoparticles to be covered, and cannot be decided at just one point. However, if the concentration of the high molecular nitrogen compound is too low, the high molecular nitrogen compound will bond to the particles but cannot cover the particles completely, so agglomeration occurs as a result of the particles bonding to each other. If the concentration of the high molecular nitrogen compound is too high, the nitrogen compound will bond to the particles, however, the nitrogen compounds also bond to each other, so that large micelles are produced, resulting in agglomeration occurring. Therefore it is desirable for the concentration of the high molecular nitrogen compound to be selected properly depending on a sort, quantity and surface area of the inorganic compound nanoparticles to be covered.

In addition, suitable covering amounts of high molecular nitrogen compound for inorganic compound nanoparticles vary depending on the sort and surface area of the inorganic compound nanoparticles and the sort and molecular weight of the high molecular nitrogen compound to be used, and cannot be decided at only one point. However, for example, when hydroxyapatite nanoparticles are covered with polyethylene imine (PEI), it is desirable for the weight ratio of PEI/nanoparticles to be 1 to 100 mg/g, and more desirably to be 10 to 50 mg/g.

When magnesium oxide nanoparticles are covered with PEI, it is desirable for the weight ratio of PEI/nanoparticles to be 0.1 to 10 mg/g, and more desirable to be 1 mg/g. Furthermore when nanoparticles of aluminum oxide, silicon dioxide, titanium oxide or iron oxide (hematite) are covered with PEI, it is desirable for the weight ratio of PEI/nanoparticles to be 1 to 100 mg/g, and more desirable to be 50 mg/g.

Since inorganic compound nanoparticles are easy to agglomerate, they are ultrasonicated after mixing with high molecular nitrogen compound solution. Ultrasonication makes it possible for inorganic compound nanoparticles to be dispersed mechanically and simultaneously cover uniformly and efficiently with the high molecular nitrogen compound.

When the method of production of calcium phosphate compound nanoparticles above mentioned is performed, particles which sustained thermal treatment can be mixed with high molecular nitrogen compound solution before crushing (ultrasonication).

By centrifuging the high molecular nitrogen compound covered inorganic nanoparticles obtained in such a way, collecting and drying the supernatant containing this covered inorganic compound nanoparticles, the inorganic compound nanoparticles covered with high molecular nitrogen compound are attained.

When ultrasonicating, the concentration of inorganic compound nanoparticles solution is adjusted high in order to improve the dispersibility and covering effect. Hence before centrifuging as mentioned above, distilled water may be added to dilute the solution if necessary.

The present invention will be explained in detail based on the following examples, however, the present invention is not restricted thereto.

The inorganic compound nanoparticles covered with high molecular nitrogen compounds obtained in the following examples were evaluated according to the following processes.

(A) Particle Shape

The shapes of the covered nanoparticles were observed using a transmission electron microscope (TEM). An H-7600 made by HITACHI Ltd., JAPAN, was used as the transmission electron microscope.

(B) Particle Size Distribution

The particle size distribution was measured for the covered nanoparticles dispersion liquid. The measurement of the particle size distribution was performed with a Submicron Particle Analyzer N5, manufactured by Becmann-Coulter Ltd., JAPAN, using a dynamic scattering method.

The results measured 3 times were shown in each of the following examples and comparative examples.

### EXAMPLE 1

Preparation of hydroxyapatite particles

Phosphate water solution and calcium salt water solution were mixed to provide a slurry containing hydroxyapatite. The slurry containing hydroxyapatite was dried with a spray-dry equipment at 200° C., and then granulated. In addition, the slurry containing hydroxyapatite was classified into a mean particle size of 10μm. The obtained hydroxyapatite particles were inserted into an electric oven and thermally treated. The thermal treatment was performed by rising the temperature at the rate of 50° C. /hr to 850° C. and then maintaining the temperature at 850° C. for four hours to obtain hydroxyapatite particles (hereinafter referred to as HA particles). Preparation of hydroxyapatite nanoparticles covered with polyethylene imine (PEI)

1.0 g of the HA particles were placed in a 45 ml pot (made from zirconia) and were dry mill treated with a Planetary ball mill (manufactured by Fritsch Ltd., :P-7) at a milling rotation of 800 rpm for 3 hours. In addition, dry milling was conducted without using media in the pot in a Planetary ball mill apparatus. HA particles were collected after dry milling to provide dry milled HA particles.

10 g of dry milled HA particles were added to 30 ml of PEI water solution that was adjusted to a concentration of 1.75 mg/ml so as to disperse; the resulting HA particles were crushed by ultrasonication with an ultrasonic generator (manufactured by TAITEC Ltd., VP-30S) (output 180 W, 5 min. ), and the surface of HA particles were covered with PEI (Wako Pure Chemical Industries, Ltd., P-70; number average molecular weight 70000) (PEI/nanoparticle weight ratio=20 mg/g). Thereafter, distilled water was added to make the total quantity to 100 ml and centrifuging was conducted at 4100×g for 5 minutes. The supernatant after centrifuging, namely the PEI covered HA nanoparticles dispersion liquid, was collected.

The results of various analysis of the PEI covered HA nanoparticles prepared in this example are shown as follows.

(A) Particle Shape

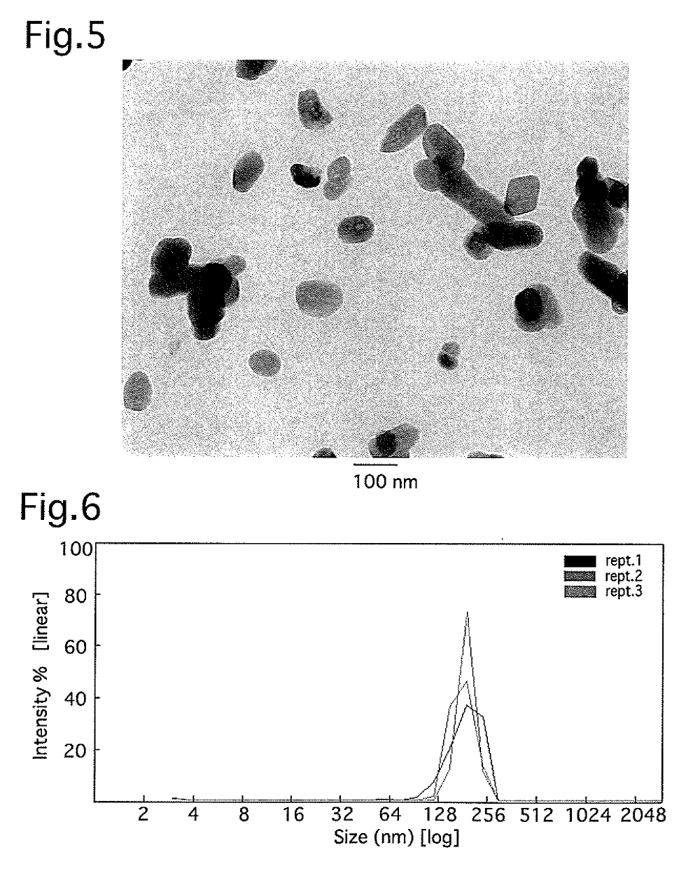

FIG. 5 is a scanning electron microphotograph of the PEI covered HA nanoparticles. The HA nanoparticles were spherical or oval-spherical with a size of 30 nm to 175 nm, and the particles were monodispersed, or dispersed with several particles gathered together.

(B) Particle Size Distribution

FIG. 6 is a graph of a particle size distribution of PEI covered HA nanoparticle dispersion liquid by dynamic scattering method, the average particle size of the HA nanoparticles in the dispersion liquid being about 187 nm.

### EXAMPLE 20

In Example 2, instead of hydroxyapatite nanoparticles, magnesium oxide nanoparticles were covered with PEI as follows. 1 g of magnesium oxide nanoparticles were added to 30 ml of PEI solution adjusted to the concentration of 0.03 mg/ml to disperse, and the magnesium oxide nanoparticles were covered with PEI by ultrasonicating (output 180 W for I min) with an ultrasonic generator (TAITEC Ltd. VP-30S)(output 180 W, 1min.)( PEI/nanoparticle weight ratio =1 mg/g). Thereafter distilled water was added to make a total amount of 50 ml, and centrifuged at 4100×g for 5 minutes. The supernatant obtained after centrifuging, namely, the PEI covered magnesium oxide nanoparticle dispersion liquid, was collected.

The results of various analysis of the PEI covered magnesium oxide nanoparticles obtained in this example are as follows.

(A) Particle Shape

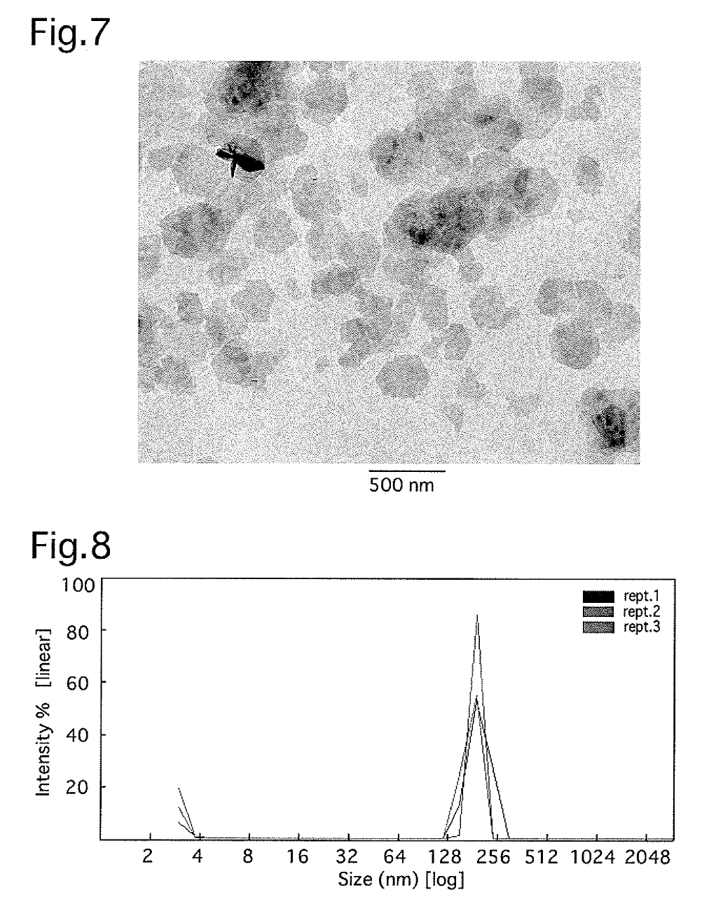

FIG. 7 is a scanning electron microphotograph of the PEI covered magnesium oxide nanoparticles. The nanoparticles were like hexagonal plates having a size of 100 nm to 250 nm, and the particles were monodispersed, or dispersed with several particles gathered together.

(B) Particle Size Distribution

FIG. 8 is a particle size distribution diagram by the dynamic scattering method of the covered nanoparticles dispersion liquid. The average particle size of nanoparticles in the dispersion liquid was about 188 nm.

### EXAMPLE 3

In Example 3, PEI covered alumina nanoparticles were prepared by the process similar to Example 2, except that 1 g of alumina nanoparticles (C. I. KASEI Ltd., JAPAN, NanoTek Powder: Al₂O₃ ) were used instead of magnesium oxide nanoparticles, and were covered with 30 ml of PEI solution which was adjusted to a concentration of 1.75 mg/ml (PEI/nanoparticles weight ratio=50 mg/g)

The results of various analysis of the PEI covered alumina nanoparticles obtained in this example are as follows.

(A) Particle Shape

The PEI covered alumina nanoparticles were dispersed with several 5 nm to 150 nm sized spherical nanoparticles gathered together.

(B) Particle Size Distribution

According to the dynamic scattering process, the average particle size of nanoparticles in the PEI covered alumina nanoparticles dispersion liquid was about 194 nm.

### EXAMPLE 4

In Example 4, PEI covered silica nanoparticles were prepared by the process similar to Example 3, except that silica nanoparticles (C. I. KASEI Ltd., JAPAN, NanoTek Powder:SiO₂) were used instead of alumina nanoparticles( PEI/nanoparticles weight ratio=50 mg/g).

The results of various analysis of the PEI covered silica nanoparticles obtained in this example are as follows.

(A) Particle Shape

The PEI covered silica nanoparticles in this example were dispersed with several 5 nm to 120 nm sized spherical silica nanoparticles gathered together.

(B) Particle Size Distribution

According to the dynamic scattering process, the average particle size of nanoparticles in the PEI covered silica nanoparticles dispersion liquid was about 212 nm.

### EXAMPLE 5

In Example 5, PEI covered titania nanoparticles were prepared by the process similar to Example 3, except that titania nanoparticles (C. I. KASEI Ltd., JAPAN, NanoTek Powder; TiO₂) were used instead of alumina nanoparticles (weight ratio of PEI/nanoparticles=50 mg/g).

The results of various analysis of the PEI covered titania nanoparticles obtained in this example are as follows.

(A) Particle Shape

The PEI covered titania nanoparticles were spherical with a size of 8 nm to 100 nm and they were monodispersed, or dispersed with several particles gathered together.

(B) Particle Size Distribution

The average particle size of nanoparticles in the PEI covered titania nanoparticles dispersion liquid was about 173 nm.

### EXAMPLE 6

In Example 6, PEI covered hematite nanoparticles were prepared by the process similar to Example 3, except that hematite particles( C I. KASEI., Ltd., JAPAN, NanoTek Powder; γ —Fe₂O₃) were used instead of alumina nanoparticles (weight ratio of PEI/nanoparticles=50 mg/g)

The results of various analysis of the PEI covered hematite nanoparticles obtained in this example are as follows.

(A) Particle Shape

The PEI covered hematite nanoparticles were spherical with a size of 6 nm to 100 nm and they were monodispersed, or dispersed with several particles gathered together.

(B) Particle Size Distribution

The average particle size of nanoparticles in the PEI covered titania nanoparticles dispersion liquid was about 113 nm.

### EXAMPLE 7

Influence of PEI Molecular Weight 1 g of Dry milled HA particles prepared similar to Example 1 were added to 3 ml of PEI solution adjusted to a concentration of 2.0 mg/ml and was dispersed, thereafter the HA particles were crushed by ultrasonicating (at output 180 W for 5 min) using an ultrasonic generator (TAITEC Inc., JAPAN; VP-30S) to cover the surface of HA particles with PEI. The average number molecular weight of PEI to be used was three kinds: 70,000, 10,000, and 1,800 (all manufactured by Wako Pure Chemical Industries Ltd., JAPAN). Thereafter, a total amount of 10 ml of distilled water was added, and was centrifuged at 4100×g for 5 minutes. The supernatant layer after centrifuging, i.e., PEI coated HA nanoparticles, were collected.

The results of various analysis of the PEI covered HA nanoparticles obtained in this example are as follows.

(A) Particle Shape

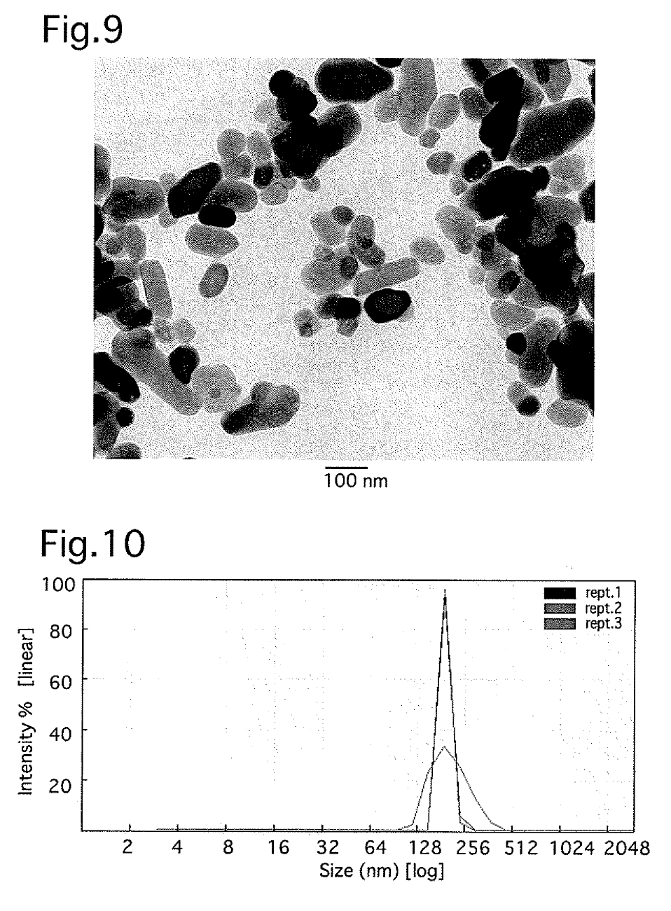

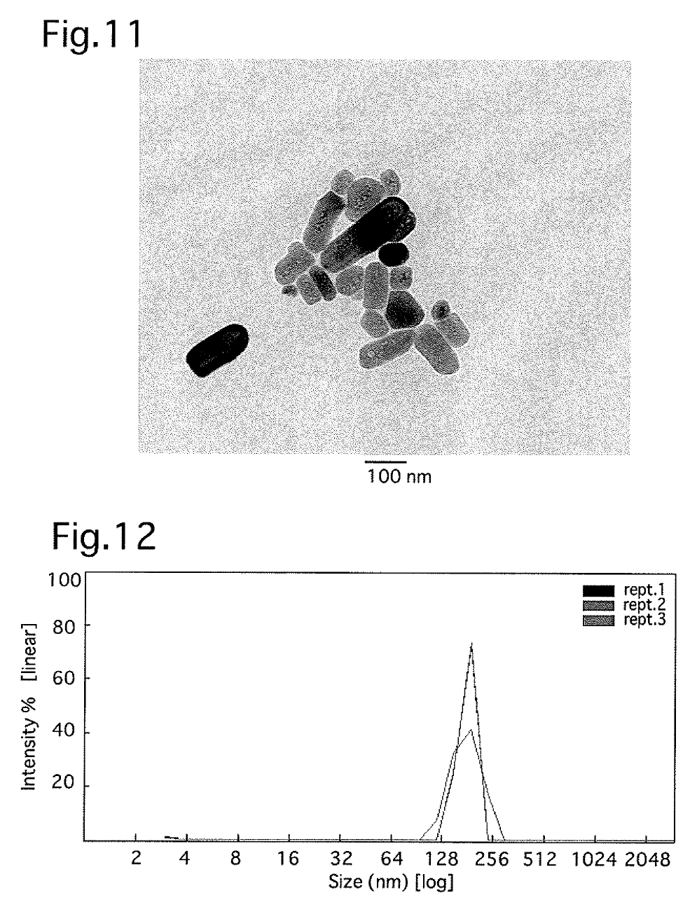

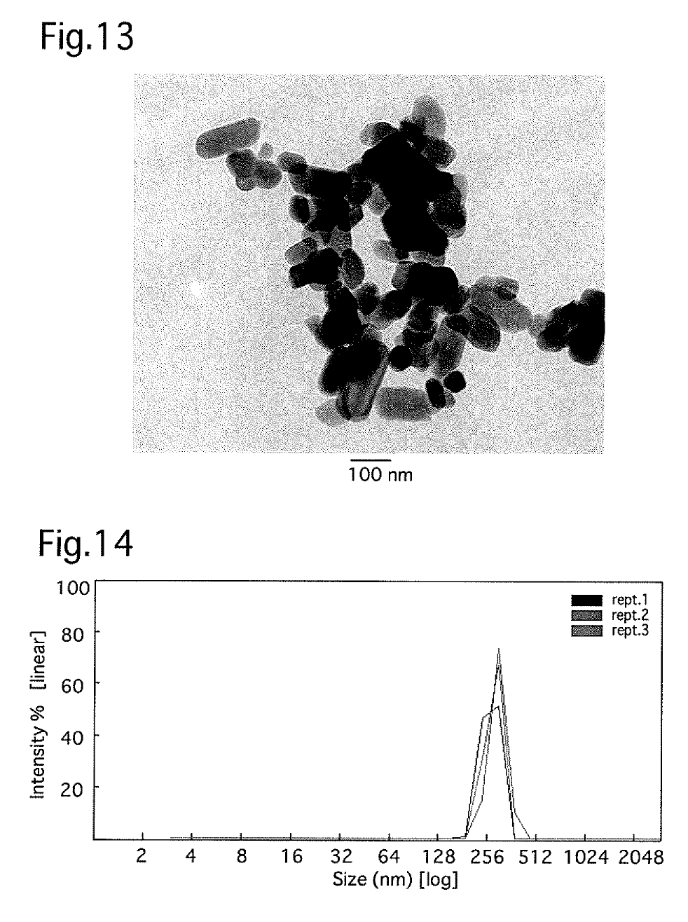

FIGS. 9, 11 and 13 show transmission electron microphotographs of HA nanoparticles covered with PEI having a number average molecular weight of 70,000, 10,000 and 1,800 respectively. These HA nanoparticles were spherical or oval-spherical with a size of 30 nm to 175 nm and they were monodispersed, or dispersed with several particles gathered together.

(B) Particle Size Distribution

FIGS. 107 12 and 14 show the particle size distribution by a dynamic scattering method of HA nanoparticles dispersion liquid covered with PEI having a number average molecular weight of 70,000, 10,000 and 1,800 respectively, and each average particle size is about 198 nm, 179 nm or 283 nm respectively.

Comparing these analysis results with the analysis results in the following Comparative examples shows that the dispersibility of nanoparticles is remarkably improved upon covering with PEI. In addition, nanoparticles used in Example 7 showed the difference in the dispersibility for the concentration of PEI and the number average molecular of PEI.

### COMPARATIVE EXAMPLE 1

Dispersibility of Hydroxyapatite Nanoparticles (not covered). 10 g of dry milled HA particles prepared similar to Example 1 were added to 30 ml of distilled water and was dispersed, and ultrasonicated (at output 180 W for 5 min) with an ultrasonic generator ( TAITEC Ltd., JAPAN VP-30S). Thereafter, additionally distilled water was added to make the whole quantity to 100 ml and was centrifuged at 4100×g for 5 minutes. HA nanoparticles were collected from the supernatant after centrifuging.

The results of various analysis of HA nanoparticles obtained in Comparative Example 1 are as follows.

(A) Particle Shape

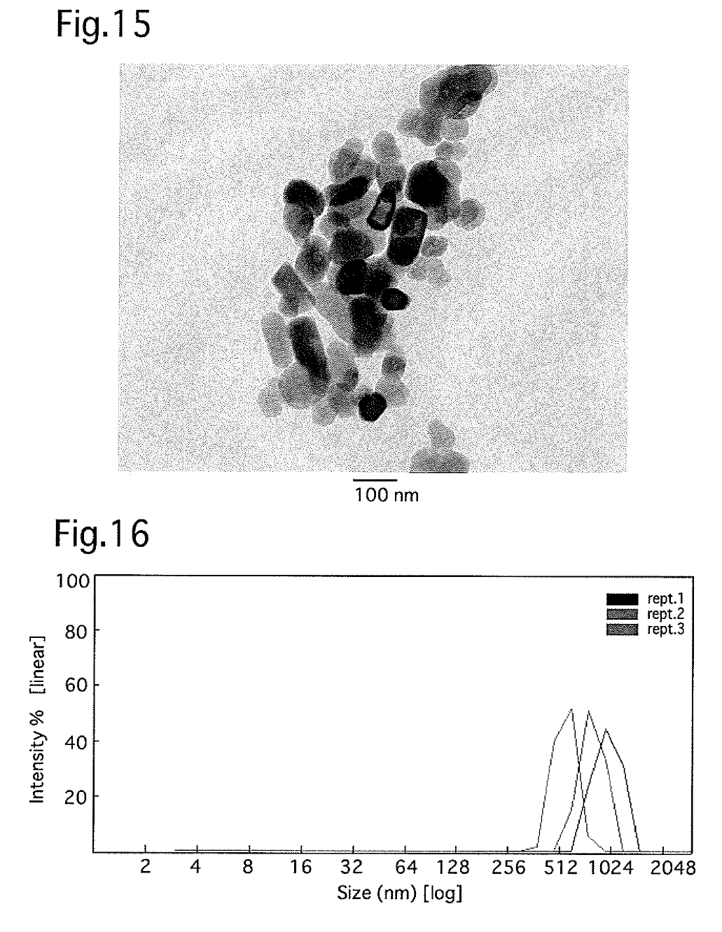

FIG. 15 shows a transmission electron microphotograph. As shown in FIG. 15, HA nanoparticles were spherical or oval-spherical with the size of 30 nm to 175 nm, and they agglomerated and formed aggregates with the size of about 300 nm.

(B) Particle Size Distribution

FIG. 16 is a diagram of particle size distribution performed by a dynamic scattering method of HA nanoparticle dispersion liquid. The average molecular weight of the HA nanoparticles in the dispersion liquid was about 1032 nm.

Comparing these analysis results with the analysis results in Example 1 shows that the dispersibility was not significantly achieved only with ultrasonic treatment of nanoparticles, whereas a remarkable improvement of dispersibility was achieved with the PEI coating.

### COMPARATIVE EXAMPLE 2

Dispersibility of Magnesium Oxide Nanoparticle (not covered).

Magnesium oxide nanoparticles were dispersed in distilled water in a similar manner to Example 2 and various analysis results about the obtained magnesium oxide nanoparticle dispersion liquid are as follows.

(A) Particle Shape

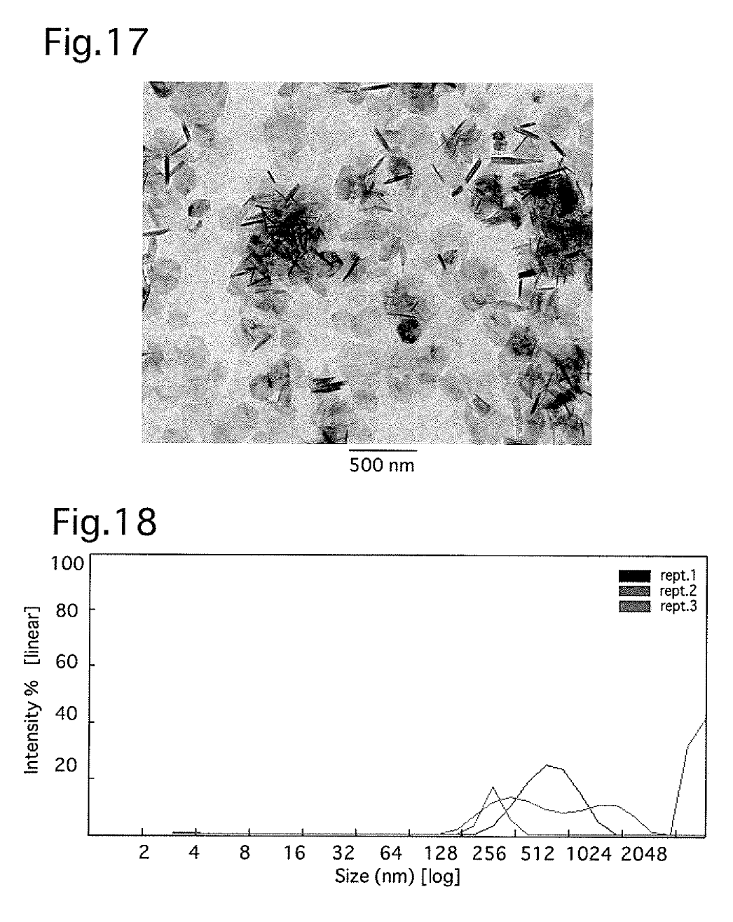

FIG. 17 shows the scanning electron microphotograph of magnesium oxide nanoparticles. As shown in FIG. 17, the magnesium oxide nanoparticles are like hexagonal plates having a size of 100 nm to 250 nm, and the particles were partly dispersed with several particles gathered together, and mainly formed solidified agglomerates.

(B) Particle Size Distribution

FIG. 18 shows the particle size distribution by a dynamic scattering method of magnesium oxide nanoparticles dispersion liquid. The average particle size of nanoparticles in the dispersion liquid was about 997 nm.

Comparing this analysis result with the analysis result in Example 2 shows that dispersibility was not significantly achieved only with ultrasonic treatment of nanoparticles, whereas a remarkable improvement of dispersibility was achieved with the PEI coating.

### COMPARATIVE EXAMPLE 3

Dispersibility Of Alumina Nanoparticles (not covered).

Alumina nanoparticles were dispersed in distilled water in a similar manner to Example 2, and various analysis results about the obtained alumina nanoparticle dispersion liquid are as follows.

(A) Particle Shape

Although spherical alumina nanoparticles dispersed with several particles gathered in sizes of 5 nm to 200 nm were observed, a considerable amount of the nanoparticles dispersed in the state where they formed solidified agglomerates was observed.

(B) Particle Size Distribution

The average particle size of alumina nanoparticles in dispersion liquid was about 266 nm.

Comparing these analysis results with the analysis result in Example 3 shows that the dispersibility was not significantly achieved only with ultrasonic treatment of nanoparticles, whereas a remarkable improvement of dispersibility was achieved with the PEI coating.

### COMPARATIVE EXAMPLE 4

Dispersibility Of Silica Nanoparticle (not covered).

Silica nanoparticles were dispersed in distilled water in a similar manner to Example 2 and various analysis results about the obtained silica nanoparticle dispersion liquid are as follows.

(A) Particle Shape

Although spherical silica nanoparticles dispersed with several particles gathered in sizes of 5 nm to 150 nm were observed, a considerable amount of the nanoparticles dispersed in the state where they formed solidified agglomerates was observed.

(B) Particle Size Distribution

The average particle size of silica nanoparticles in dispersion liquid was about 222 nm.

Comparing these analysis results with the analysis result in Example 4 shows that the dispersibility was not significantly achieved only with ultrasonic treatment of nanoparticles, whereas a remarkable improvement of dispersibility was achieved with the PEI coating.

### COMPARATIVE EXAMPLE 5

Dispersibility Of Titania Nanoparticles (not covered).

Various analysis results of the dispersion liquid of titania nanoparticles dispersed in the distillation water by the process similar to Example 5 are as follows.

(A) Particle Shape

Although spherical titania nanoparticles dispersed with several particles gathered in sizes of 8 nm to 100 nm were observed, a considerabl amount of the nanoparticles were dispersed in the state where they formed solidified agglomerates was observed.

(B) Particle Size Distribution

The average particle size of titania nanoparticles in the dispersion liquid was about 296 nm.

Comparing these analysis results with the analysis result in Example 5 shows that the dispersibility was not significantly achieved only with ultrasonic treatment of nanoparticles, whereas a remarkable improvement of dispersibility was achieved with the PEI coating.

### COMPARATIVE EXAMPLE 6

Dispersibility Of Hematite Nanoparticle

Various analysis results of the dispersion liquid of hematite nanoparticles dispersed in the distillation water by the process similar to Example 6 are as follows.

(A) Particle Shape

Although spherical hematite nanoparticles dispersed with several particles gathered in sizes of 5 nm to 100 nm were observed, a considerable amount thereof in the state where they formed solidified agglomerates were observed.

(B) Particle Size Distribution

The average particle size of titania nanoparticles in dispersion liquid was about 900 nm.

Comparing this analysis result with the results in Example 6 shows that the dispersibility was not significantly achieved only with ultrasonic treatment of nanoparticles, whereas a remarkable improvement of dispersibility was achieved with the PEI coating.

Although the invention has been described with reference to particular materials and embodiments, it is to be understood that the invention is not limited to the particulars disclosed and extends to all equivalents within the scope of the claims.

What is claimed is:

1. Highly dispersible inorganic compound nanoparticles comprising:
a high molecular nitrogen compound having at least two amino groups selected from primary amino groups, secondary amino groups and tertiary amino groups; and
inorganic compound nanoparticles bonded to at least one amino group of said at least two amino groups, wherein said inorganic compound nanoparticles are covered with said high molecular nitrogen compound.

2. The highly dispersible inorganic compound nanoparticles according to claim 1, wherein the number average molecular weight of said high molecular nitrogen compound is in a range from 800 to 100,000.

3. The highly dispersible inorganic compound nanoparticles according to claim 1, wherein said high molecular nitrogen compound comprises, in the molecular thereof, primary amino groups, secondary amino groups, and tertiary amino groups in a repeating unit.

4. The highly dispersible inorganic compound nanoparticles according to claim 1, wherein said high molecular nitrogen compound comprises one of a straight-chain, a branched-chain and a cyclic polyamine compound or a mixture thereof.

5. The highly dispersible nitrogen compound nanoparticles according to claim 4, wherein said polyamine compound comprises polyethylene imine.

6. The highly dispersible nitrogen compound nanoparticles according to claim 1, wherein said inorganic compound comprises one of calcium phosphate compound and metal oxide.

7. The highly dispersible nitrogen compound nanoparticles according to claim 6, wherein said calcium phosphate compound comprises hydroxyapatite.

8. The highly dispersible nitrogen compound nanoparticles according to claim 6, wherein said metal oxide comprises one of alumina, silica, magnesium oxide, and iron oxide.

9. A method of production for highly dispersible inorganic compound nanoparticles, comprising:
mixing inorganic nanoparticles with a high molecular nitrogen compound having at least two amino groups selected from primary amino groups, secondary amino groups, and tertiary amino groups;
ultrasonicating the mixture of said inorganic nanoparticles with said high molecular nitrogen compound after said mixing;
centrifuging said mixture after said ultrasonication;
collecting the supernatant of said mixture after said centrifuging;
and drying said supernatant.

10. The method of production for highly dispersible inorganic compound nanoparticles according to claim 9, wherein the number average molecular weight of said high molecular nitrogen compound is in a range from 800 to 100,000.

11. The method of production for highly dispersible inorganic compound nanoparticles according to claim 9, wherein said high molecular nitrogen compound comprises, in the molecular thereof, primary amino groups, secondary amino groups, and tertiary amino groups in a repeating unit.

12. The method of production for highly dispersible inorganic compound nanoparticles according to claim 9, wherein said high molecular nitrogen compound comprises one of a straight-chain, a branched-chain and a cyclic polyamine compound or a mixture thereof.

13. The method of production for highly dispersible inorganic compound nanoparticles according to claim 12, wherein said polyamine compound comprises polyethylene imine.

14. The method of production for highly dispersible inorganic compound nanoparticles according to claim 9, wherein said inorganic compound comprises one of calcium phosphate compound and metal oxide.

15. The method of production for highly dispersible inorganic compound nanoparticles according to claim 14, wherein said calcium phosphate compound comprises hydroxyapatite.

16. The method of production for highly dispersible inorganic compound nanoparticles according to claim 14, wherein said metal oxide comprises one of alumina, silica, magnesium oxide and iron oxide.

17. The method of production for highly dispersible inorganic compound nanoparticles according to claim 9, wherein a solvent for said high molecular nitrogen compound comprises one of water and an organic solvent.
